(19) United States
(12) Patent Application Publication
(10) Pub. No.: US 2026/0242202 A1
(43) Pub. Date: Aug. 20, 2026

(54) A SYSTEM FOR CLEANSING A FLUID PATHWAY OF A FLUID DISPENSING ASSEMBLY

(71) Applicant: Zip Heaters (Aust) Pty Ltd, New South Wales (AU)

(72) Inventors: Kevin Ralph MOULT, New South Wales (AU); Alec WAUGH, New South Wales (AU)

(21) Appl. No.: 19/118,413

(22) PCT Filed: Oct. 4, 2023
(86) PCT No.: PCT/AU2023/050957

§ 371 Date: Apr. 4, 2025

(30) Foreign Application Priority Data
Oct. 4, 2022 (AU) 2022902872

(51) Int. Cl. B67D 1/07; C02F 1/00; C02F 1/461

(52) U.S. Cl. CPC B67D 1/07; C02F 1/003; C02F 1/46109; B67D 2001/075; B67D 2210/0001; C02F 2201/006; C02F 2201/4612

(57) ABSTRACT

There is disclosed herein a system for cleansing a fluid pathway of a fluid dispensing assembly, the system including: an inlet to receive a supply of fluid to be delivered under pressure along the fluid pathway; an outlet in fluid communication downstream of said inlet to dispense fluid; and a replaceable cleansing cartridge locatable in fluid communication downstream of said inlet, the cartridge having at least a filter chamber and an anolyte generation chamber, the filter chamber including a filter medium and the anolyte generation chamber being configured to generate an anolyte, with the filter chamber and the anolyte generation chamber being in fluid communication so that the fluid received from the inlet passes through both chambers before exiting the outlet to deliver fluid to the fluid dispensing assembly.

### FIELD

The present invention relates to a system for cleansing a fluid pathway of a fluid dispensing assembly. In particular, the invention relates to replaceable cartridges for use with a fluid dispensing assembly and methods of cleansing a fluid pathway of a fluid dispensing assembly.

The invention has primarily been developed for use with drinking water dispensers and water reticulation paths and will be described hereinafter with reference to this non-limiting application.

### BACKGROUND

A known water dispenser or fluid dispensing assembly typically comprises a fluid pathway that conveys mains water to a water tank where it is then dispensed to an outlet for use by a consumer. Modern dispensers can include an outlet that dispenses chilled drinking water, sparkling water and/or boiling water.

A disadvantage of known dispensers is that the water contained within the fluid pathway or water reticulation path is susceptible to common waterborne bacteria and opportunist pathogens (e.g. Legionella and Pseudomonas aeruginosa) infiltration and contamination. Water that is contaminated with Legionella bacteria or pathogens can spread into urban water systems such as residential or commercial plumbing systems and water tanks, and subsequently fed into the fluid pathway of chilled water dispensers. The water may alternatively be contaminated through back-contamination at the water outlet spouts. Filtration systems within conventional chilled water dispensers may not adequately filter out all bacteria or pathogens. Such known systems do not run system wide cleansing and/or sanitising steps on installation of the cartridge into the dispensing assembly.

Water that is contaminated with bacteria or pathogens is particularly harmful to persons with weak immune systems or patients with respiratory illnesses, possibly occasioning death. For example, Legionella exposure can occur when a person inhales small droplets of water (e.g. from a showerhead or whilst drinking water dispensed from a chilled water dispenser) containing Legionella bacteria.

Thermal treatment, chlorination, chloride dioxide, copper and silver positive ions, ozone, filtering, ultraviolet rays have been used to treat water.

Whilst most mains water supplies have residue chlorine or chloramine levels, filtration systems with activated carbon remove the chlorine/chloramine. This leaves reticulation post filtration unprotected and open to bacteria proliferation.

Known sanitising systems for water reticulation paths are complex, not user-friendly and do not adequately reduce or eliminate bacteria or opportunist pathogen proliferation within the fluid pathway. Accordingly, there is a need for an improved sanitising or cleansing system.

### SUMMARY

It is an object of the present invention to substantially overcome, or at least ameliorate, one or more of the disadvantages of existing arrangements, or at least provide a useful alternative to existing arrangements.

There is disclosed herein a system for cleansing a fluid pathway of a fluid dispensing assembly, the system including:
an inlet to receive a supply of fluid to be delivered under pressure along the fluid pathway;
an outlet in fluid communication downstream of said inlet to dispense fluid; and
a replaceable cleansing cartridge locatable in fluid communication downstream of said inlet, the cartridge having at least a filter chamber and an anolyte generation chamber, the filter chamber including a filter medium and the anolyte generation chamber being configured to generate an anolyte, with the filter chamber and the anolyte generation chamber being in fluid communication so that the fluid received from the inlet passes through both chambers before exiting the outlet to deliver fluid to the fluid dispensing assembly.

Preferably, the cartridge further includes a key or cap and a base configured to close a generally tubular housing defining a longitudinal axis, with the housing surrounding the chambers.

Preferably, the cartridge further includes an electrolytic system having an electrode assembly.

Preferably, the electrode assembly includes a cathode plate and an anode plate, with the cathode plate and the anode plate being spaced apart to allow fluid to travel therebetween.

Preferably, fluid travelling along the fluid pathway reacts with the electrode assembly to generate the anolyte.

Preferably, the anolyte being generated is at a low concentration level to maintain a clean fluid pathway.

Preferably, the concentration of the anolyte being generated is maintained at between 0.2 to 0.5 ppm.

Preferably, the system is adapted to periodically switch the polarity of the cathode and anode plates.

Preferably, the electrode assembly further includes a passive electrode.

Preferably, the system further includes a pressure compensating flow restrictor configured to regulate a flow rate of the fluid delivered to the fluid pathway to facilitate mixing of the fluid within the cleansing cartridge to an effective cleansing concentration.

Preferably, the filter medium includes a pleated membrane, a particulate removal medium and/or a carbon filtration material.

Preferably, the anolyte generated by the anolyte generation chamber is hypochlorous acid.

Preferably, the chambers are spaced in series axially along said axis, with the anolyte generation chamber being located downstream from the filter chamber.

Alternatively, the chambers are spaced parallel radially about said axis.

Alternatively, the chambers are sequentially connected with fluid passing firstly through the filter chamber and subsequently through the anolyte generation chamber.

Preferably, the key includes a fluid inlet port to permit fluid moving into the cartridge, a fluid outlet port to permit fluid to move out of said cartridge.

Preferably, the key includes an electrical port to energise the electrolytic system located within said cartridge.

Preferably, the key includes at least one sensor to measure characteristics of the cartridge and/or fluid traveling along the fluid pathway.

Preferably, the key includes key portions operatively associated with corresponding lock portions on a head of said fluid dispensing assembly.

Preferably, the key and lock portions include a mechanical arrangement.

Alternatively, the key and lock portions include an electronic arrangement.

Preferably, the system includes a UV unit locatable along said fluid pathway.

Preferably, the system includes a control unit to operate tasks within said cartridge, the control unit being electrically connected to said electrical port.

Preferably, one said task is a self-cleaning/sanitising function.

Preferably, one said task includes scheduling and sequencing of electrochemical metering.

Preferably, the control unit is capable of sending data via a signal to an external server to relay performance and water quality information to said server.

Preferably, the control unit provides real time location tracking of said cartridge.

Preferably, the control unit responds to a user input to conduct a cleansing/sanitising cycle of the fluid pathway.

Preferably, when a new cartridge is installed in said fluid dispensing assembly, said control unit activates a cleansing/sanitising cycle, said sensor determining a cleansing/sanitising dwell time by determining the system's ability to generate anolyte of a particular concentration.

Preferably, said dwell time ranges from 8 minutes to 24 minutes of cleansing/sanitising.

Preferably, the electrolytic system further includes upper and lower electrolytic electrode plates locatable within corresponding grooves within upper and lower supports, said supports including apertures adapted to direct fluid through said plates, and an elongate electrode extending from said key towards said base and electrically connected to said electrical port such that said electrode can create an electrochemical reaction within said cartridge to said fluid as it travels along said fluid pathway.

Preferably, the control unit is configured to control the flow to current ratio to control a concentration of anolyte in the fluid pathway.

Preferably, the system provides a continuous, in line low-level cleansing of the fluid pathway.

There is also disclosed herein a replaceable cleansing cartridge to be operatively associated with a system for cleansing a fluid pathway of a fluid dispensing assembly, the cartridge including a key and a base configured to close a generally tubular housing defining a longitudinal axis, the housing surrounding the chambers, the cartridge include a filter chamber and an anolyte generation chamber, the filter chamber including a filter medium and the anolyte generation chamber being configured to generate an anolyte, the chambers being in fluid communication so that said fluid passes through both chambers before exiting said outlet to deliver cleansed fluid to the fluid dispensing assembly.

Preferably, the cartridge provides continuous, in line low-level cleansing of the fluid pathway.

Preferably, the key is configured to be utilised with existing canisters and/or dispensing assemblies.

There is also disclosed herein a method of cleansing a fluid pathway of a fluid dispensing assembly, the method including the steps of:
providing a flow of fluid to a replaceable cleansing cartridge, wherein the cartridge includes a filter chamber and an anolyte generation chamber, the flow of fluid passing firstly through the filter chamber and subsequently through the anolyte generation chamber;
generating a sanitising anolyte in the fluid via the anolyte generation chamber; and
delivering the fluid from the anolyte generation chamber to a fluid dispenser of the fluid dispensing assembly.

Preferably, the fluid delivered to the fluid dispenser has a low level or concentration of the sanitisng anolyte.

Preferably, the method further includes a step of measuring a level of free chlorine in the fluid and adjusting the concentration of the santising anolyte being generated based on the level of free chlorine detected.

Preferably, the step of measuring and adjusting provides a feedback system for a continuous cleansing of the fluid pathway.

Preferably, the method includes a further step of stopping the flow of fluid and de-energising the anolyte generation chamber to stop the generation of anolyte in the fluid.

Preferably, the method includes a further step of maintaining the level or concentration of the sanitising anolyte in a dwell stage to keep the fluid pathway clean.

Preferably, the method includes a further step of regularly generating the sanitising anolyte in the fluid during periods of high usage.

Preferably, the method incudes a further step of maintaining the anolyte generation at a rest or dormant state during periods of low usage.

### BRIEF DESCRIPTION OF THE DRAWINGS

For a more complete understanding of the present invention, exemplary embodiments of the invention are explained in more detail in the following description with reference to the accompanying drawing figures, in which like reference signs designate like parts and in which:

FIG. 1 is a cartridge of an embodiment of the invention;

FIG. 2 is a parts exploded view of FIG. 1; and

FIG. 3 is a sectional view of an embodiment of the invention.

### DETAILED DESCRIPTION

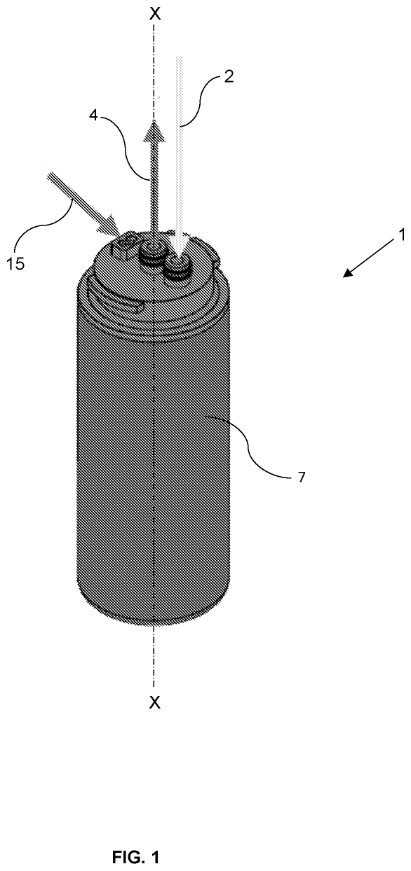

In FIGS. 1 to 3 of the accompanying drawings, there is schematically depicted various embodiments of a replaceable cleansing cartridge 1 for use with a system (not shown) for cleansing or sanitising a fluid pathway of a fluid dispensing assembly. Throughout the specification, the terms ‘cleansing’, ‘cleaning’, and ‘sanitising’ may be used interchangeably. The system may include an inlet to receive a supply of fluid to be delivered under pressure along the fluid pathway and an outlet in fluid communication downstream of the inlet to dispense fluid to the fluid dispensing assembly. The fluid pathway of the fluid dispensing assembly may extend from the inlet to the outlet. The replaceable cleansing cartridge 1 is locatable in fluid communication downstream of the inlet and typically connected to a head (not shown) on the dispensing assembly. The system may be configured to at least provide a continuous, in line low-level cleansing of the fluid pathway and/or maintain a clean fluid pathway, as will be described in detail below.

In the depicted embodiment, the cartridge 1 includes at least a filter chamber 3 and an anolyte generation chamber 41. Throughout the specification, the terms ‘anolyte generation chamber’ and ‘anolyte generator’ may be used interchangeably to indicate a component or zone that is adapted to generate anolyte. The cartridge 1 may further include an inlet port 2, an outlet port 4, and a fluid pathway 40 between the inlet port 2 and the outlet port 4. The fluid pathway 40 of the cartridge 1 may form a section or portion of the fluid pathway of the fluid dispensing assembly. The system may be configurable to control the concentration of anolyte being generated by the anolyte generation chamber 41 such that the system may remain free of bacteria without impacting the taste of the fluid (water) being dispensed from the fluid dispenser.

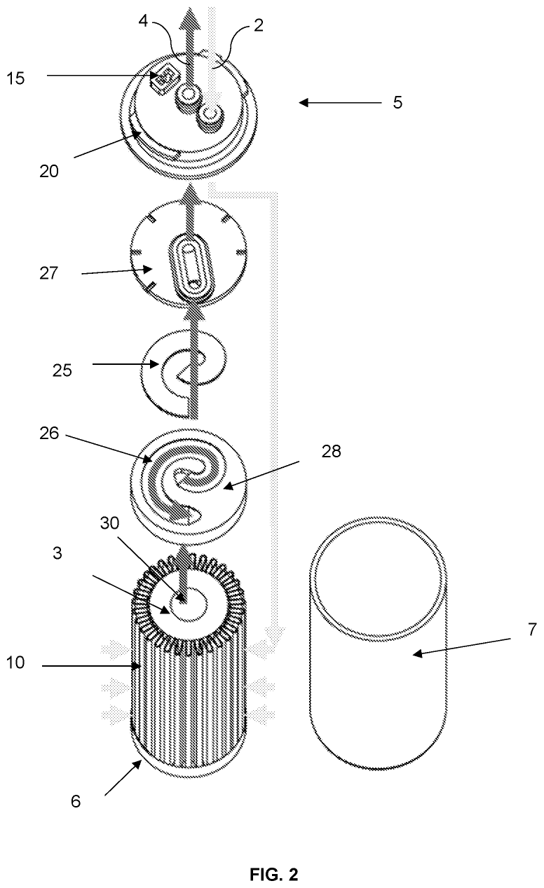

As best shown in FIG. 2, one form of the cartridge 1 may include a cartridge connection key/cap 5 and a base 6 configured to close a generally tubular housing 7 defining a longitudinal axis X-X, with the housing 7 surrounding the chambers 3 and 41. The inlet and outlet ports 2 and 4 of the cartridge 1 may be provided in the key/cap 5. It will be appreciated that the configuration of the cartridge 1 and components thereof is not necessarily limited to the configuration shown and described herein, and may be customised depending on the design or installation requirements of the system.

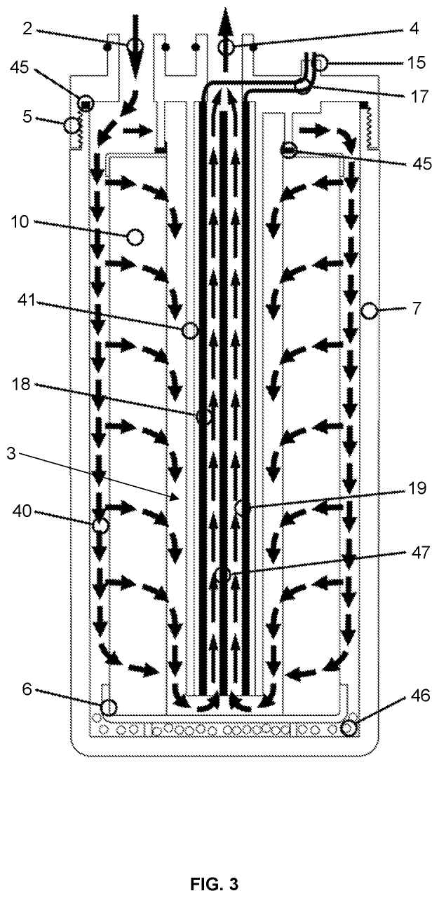

The filter chamber 3 may include a filter medium 10. Fluid that enters the inlet port 2 and travels along the fluid pathway 40 may pass through both the filter chamber 3 and the anolyte generation chamber 41 before exiting the outlet port 4. In a preferred form, the filter medium 10 includes a pleated membrane, a particulate removal medium, and/or a carbon filtration material and the anolyte generation chamber 41 is adapted to generate an anolyte. The anolyte may be hypochlorous acid in one preferred form. It is understood that hypochlorous acid is an organic substance that has strong antimicrobial properties. In other forms, the anolyte may be sodium hypochlorite. It will, however, be appreciated that the filter medium 10 may include other suitable material and the anolyte may include other substances suitable for cleansing the fluid or maintaining a clean fluid pathway, depending on the design requirements of the system. The filter medium 10 may also be replaceable and/or recyclable. The concentration of the anolyte being generated may be configured depending on the requirements of the system and/or the water condition, as will be discussed in further detail below. The cartridge 1 may include an electrolytic system associated with the anolyte generation chamber In one configuration, the chambers 3 and 41 may be spaced in series axially along the axis X-X, whereby the anolyte generation chamber 41 is located downstream of the filter chamber 3. In another configuration, the chambers 3 and 41 may be spaced parallel radially about the axis X-X. In a preferred form, and as shown in FIG. 3, the chambers 3 and 41 are sequentially connected with fluid passing firstly through the filter chamber 3 (and thereby the filter medium 10) and then subsequently through the anolyte generation chamber 41. It will be appreciated that the anolyte generation chamber 41 is preferably located downstream from the filter chamber 10 and prior to the exit from the cartridge 1. Filtering the water prior to generation of the anolyte may at least support a regular and/or consistent concentration of anolyte being generated.

As shown in the Figures, the key/cap 5 is provided with the inlet fluid port 2 of the cartridge 1 to permit fluid moving into the cartridge 1 and the outlet fluid port 4 to permit fluid moving out of the cartridge 1. In one form, the key/cap 5 may further include an electrical port 15 to energise, via connections 17, the electrolytic system located within the cartridge 1 and associated with the anolyte generation chamber 41. The electrolytic system may include an electrode assembly. In one form, the electrode assembly includes a cathode plate 18 and an anode plate 19. The cathode plate 18 and the anode plate 19 may be spaced apart to allow fluid to travel therebetween. Fluid travelling along the fluid pathway 40 may react (via an electrochemical reaction) with the electrode assembly to generate the anolyte. It will be appreciated that the system may have more than one cathode plate 18 and/or more than one anode plate 19.

The key/cap 5 may be integrally formed with the cartridge 1 or may alternatively be provided as a separately formed (standalone) item which can be retrofitted with existing cartridges and/or dispensing systems. In some forms, the key/cap 5 may include at least one sensor (not shown) to measure characteristics of the cartridge 1, the filter medium 10, the electrode assembly, and/or the fluid traveling along the fluid pathway. In some forms, a control unit (not shown) to operate tasks within the cartridge 1 may be provided. The control unit may be associated with the cartridge. In other forms, the control unit may be located in the fluid dispensing assembly rather than the cartridge 1. The control unit may be electrically connected to the electrical port 15. In one configuration, the control unit may be configured to operate a self-cleaning function, in another configuration, the control unit may be configured to include scheduling and sequencing of electrochemical metering. In an alternate embodiment, the control unit may be located on the cartridge 1 itself and/or the key/cap 5.

Further, in one form, the control unit may be configured to send data via a signal to an external server to relay performance and fluid quality information to a server, computer, and/or mobile device. The control unit may be configured to include real-time location tracking of the cartridge 1.

In some embodiments (not shown), the cartridge 1 or the overall system may be provided with a flow restrictor. The flow restrictor may be configured to regulate a flow rate of the fluid delivered to the fluid pathway to facilitate the generation of the anolyte in the fluid within the cartridge 1 to an effective cleansing concentration. It will be appreciated that the flow restrictor may be located anywhere in the fluid pathway, may have two or more flow rates depending upon the fluid path selected, and may be controlled on unit or remotely. An outlet (not shown) may be provided in fluid communication downstream of the cartridge outlet port 4 to deliver fluid from the cartridge 1 to the fluid dispensing assembly.

As best shown in FIG. 2, the key/cap 5 may include shaped portions 20 forming a key system operatively associated with a corresponding lock (not shown) on the fluid dispensing assembly. In one configuration, the key and lock portions may include a mechanical arrangement. In another configuration, the key and lock portions may include an electronic arrangement. In one form, and as noted above, the key/cap 5 may be a discrete product which can be retrofitted between existing cartridges and dispensing assembly heads. In some forms, the system or cartridge may include a UV unit locatable along the fluid pathway.

Referring to FIG. 2, the cartridge 1 may, in some embodiments, include upper and lower electrolytic electrode plates 25, 26 locatable within corresponding grooves within upper and lower supports 27, 28. The supports 27, 28 may include apertures adapted to direct fluid through the plates 25, 26 and an elongate electrode 30 extending from the head 5 towards the base 6 and electrically connected to the electrical port 15, such that the electrode 30 can create an electrochemical reaction within the cartridge 1 to the fluid as it travels along the fluid pathway 40.

A further embodiment, in cutaway, is shown in FIG. 3, where the enclosure cap/filter interface key 5 is connected to the chamber enclosure/housing 7 by way of a threads and seals 45. The fluid pathway is shown as item 40. The electrical interface point 15 may be provided with electrical connections such as wires 17 to energise the cathode and anode plates 18 and 19. It should be noted that by having a simple threaded connection, the cap/key 5 can be easily separated from the housing 7. This may at least allow for the replacement of the filter medium 10 and/or the limescale reduction/polyphosphate component 46 described in further detail below. The replacement of these components may occur whilst the cathode and anode plates 18 and 19 still have an extended life. Additionally, in some forms, the polarity of the cathode and anode plates 18 and 19 may be periodically switched (by way of smart logic, for example) to prolong the life of the cartridge 1. That is, the cathode plate 18 becomes the anode plate 19, and vice versa.

It will be appreciated that the filter medium 10 may be adapted for particulate and chlorine/lead reduction. Centrally located is the anolyte generation chamber 41. The fluid pathway 40 extends across both sides of the filter medium 10 as shown. In some embodiments, a limescale reduction additive/polyphosphate component 46 may be provided at the base 6. In other embodiments, the electrode assembly may include a passive electrode 47 provided between the cathode plate 18 and the anode plate 19. It will be appreciated that the inclusion of the passive electrode 47, or any other additional electrode in the electrode assembly, may increase the surface area of the electrodes to increase anolyte generation.

In a further embodiment, the dispensing assembly may be controlled via a touch screen located on the assembly, from a personal computing device, mobile device and/or via an application. The mobile application could be configured to scan barcodes, QR codes or the like, to link the dispensing assembly and cartridges to assist with compliance, warranty and/or best performance. A series of tasks and operations would be available for a user and/or technician to select via one of the user interfaces. For example, a user could request a cleansing/sanitising. cycle of the fluid pathway at any time, such as when returning from a holiday and the fluid pathway has not been used for some time.

A further embodiment would include, as an automatic operation when a new cartridge is located in the system, a cleansing/sanitising cycle that commences before a user operates the fluid dispensing assembly. A sensor would determine a cleansing/sanitising dwell time by determining the system's ability to generate anolyte of a particular concentration. That is, the sensor would determine whether the cleansing/sanitising medium has potentially degraded over time. The dwell time may range from between 8 minutes to 24 minutes of cleansing/sanitising, depending upon the anolyte generation ability. The control unit may be configured to control the flow to current ratio to control a concentration of anolyte in the fluid pathway. This concentration may be, for example, between 5 ppm to 10 ppm. If the user selects to have no dwell time and/or the cleansing/sanitising cycle to operate continuously, then a concentration of under 1 ppm may be more typical. In the case of the anolyte generation, the ability to create an anolyte at a particular concentration level will determine the dwell time. The system can have a maximum concentration when the cartridge is new, and could have a fractional drop in maximum concentration with the use of the electrode plates.

The concentration in the anolyte can be influenced by: the condition of the electrode plates; the electrical power (voltage and current) applied; the flow rate of the water; and salts, pH, total dissolved solids (TDS), chlorine/chloride levels, and other water condition such as, but not limited to, the base line municipal water quality, water temperature, conductivity of the water, and fluoride levels. In one example, the voltage may be controlled to control the current, and the current controls the concentration of anolyte generated. By configuring, measuring, or predicting these conditions, it may be possible to estimate the concentration that the system can achieve and thereby assign a dwell time accordingly. Additionally, by measuring certain water conditions, it may be possible to provide a feedback system to the control unit and increase the anolyte concentration to the most appropriate concentration for sanitising. (i.e. anolyte concentration level that is best to maintain a clean and bacteria-free fluid dispensing system). In a preferred embodiment, the continuous cleaning would be undertaken at between approximately 0.2 to 0.5 ppm first as the norm. A boosted or specific sanitising function may then be activated for periodic cleaning.

A method of continuously cleansing a fluid pathway of a fluid dispensing assembly will now be described. It will be appreciated that the operation of the various forms of the system and cartridge 1 described above is not necessarily limited to the method steps described below, and may be configured depending on the design or installation requirements of the system.

In this method, the replaceable cleansing cartridge is installed in a system which includes an inlet to receive a supply of fluid and an outlet to dispense fluid to the fluid dispensing assembly. The fluid that enters the system from the inlet may be distributed to the cartridge through a solenoid controlled valve (safety valve).

As best shown in the example of FIG. 3, the fluid that enters the cartridge 1 via the inlet port 2 passes through the filter medium 10 in the filter chamber 3. This step may at least allow for the removal or filtration of particulate matter, cysts, chlorine taste, odour, and/or lead. The fluid that exits the filter chamber 3 then passes through the anolyte generation chamber 41. In this anolyte generation chamber 41, the electrolytic system comprising the electrode assembly may be energised to result in the generation of a sanitising anolyte in the fluid to cleanse the fluid. As discussed above, the concentration of the anolyte being generated may be controlled, for example by controlling the current applied to the electrolytic system.

In a preferred method of operation, the fluid that exits the anolyte generation chamber 41 may pass through a feedback system. In one form, the feedback system includes a free chlorine meter which measures the level of free chlorine in the fluid and provides a signal to a control unit of the system indicative of the level of free chlorine in the fluid. The control unit may then make the required adjustments to the concentration of anolyte being generated, based on the level of free chlorine detected.

The fluid that subsequently exits the cartridge 1 via the outlet port 4 may have a low level/concentration of sanitising anolyte. In some forms of the system, the fluid that exits the cartridge 1 may then pass through various components such as, but not limited to, a flowmeter, a water diverter valve, and a cold water valve to then be delivered into a chilling storage tank, where the fluid remains until the user dispenses fluid from the fluid dispenser (tap outlet). The fluid that is dispensed from the fluid dispenser may thus be fluid having a low level/concentration of sanitising anolyte.

In one form of the method, when the flow of fluid is stopped, the electrolytic system may be de-energised. Further, when the system is not in use, the low concentration sanitising anolyte may be in a dwell stage and acts on the internals of the reticulation to keep the system clean. As noted above, activation of the fluid dispenser (tap outlet) may allow for the dispensation of fluid with a low level/concentration of sanitising anolyte from the chilled storage tank. It is envisaged that as the level of fluid in the chilled storage tank drops, due to the dispensing from the fluid dispenser, the above process may start again.

It is further envisaged that, in some forms of the method, during periods of high usage, the system may be controlled to generate the sanitising anolyte regularly. In other forms of the method, during periods of low or no usage when there is no flow of water through the system, the system may be controlled to keep the anolyte generator at rest or dormant.

In a further form of the method, a periodic “boost” function of sanitising may be included. It will be appreciated that this boost function involves the generation of a higher concentration of sanitising anolyte in the fluid.

It is envisaged that the boost function may be programmed to occur during early morning hours (of no usage), whereby the fluid dispenser tap may include illuminated lights that flash rapidly or other visual indications to advise the user that a special process is underway.

The fluid in the system is at rest, specifically in the cartridge which houses the filter chamber and the anolyte generation chamber. The system may be programmed to automatically empty the fluid in the chilled storage tank by continuous dispensing of fluid from the tank until a low tank level is reached.

The controller may then energise the anolyte generator for a period to build a sanitising anolyte in the anolyte generation chamber. Once the preferred or target concentration of sanitising anolyte is reached, the valves in the system may be opened and the fluid in the anolyte generation chamber may be moved out of the reticulation system. This process may be repeated until the anolyte dosed fluid has reached the tank and the tank is filled up to an upper level. The system may then be left in a dwell phase, where the sanitising of the system is complete. The dwell period may be dependent on the concentration of anolyte achieved, and as discussed above, may be between 8 to 24 minutes, for example.

At the end of the dwell period, the system may be programmed to pump the sanitising fluid from the tank through the dispenser tap. Once the tank is empty, the system may then be programmed to refill the tank with fluid that excludes the anolyte. This flushing process may involve any number of empty and refill cycles, and preferably three cycles to ensure that the levels of anolyte are back to the low levels prior to the activation of the boost function. On the next use of the fluid dispenser, the system may be programmed to revert to a continuous sanitising/cleansing function.

It will be appreciated that the number, location, and/or presence of the various components of the cartridge 1 described above are not necessarily limited to the arrangement as shown in the drawings and described herein, and may be adjusted or removed depending on the design requirements of the cartridge 1 and/or the overall system. It will further be appreciated that the various forms of the cartridge 1 and accompanying system and method of cleansing/sanitising described above may allow for a miniaturised arrangement of a built-in anolyte generator to be provided in a consumable filter housing, whereby the anolyte generator is locatable downstream from the filtration component and prior to the exit from the cartridge. The various forms of the above arrangements may at least allow for a continuous cleansing of a fluid pathway of a fluid dispensing assembly, and the eventual dispensation of fluid with a low level/concentration of sanitising anolyte at a consistent quality.

Although specific embodiments of the invention are illustrated and described herein, it will be appreciated by those of ordinary skill in the art that a variety of alternative and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, etc. are used merely as labels, and are not intended to impose numerical requirements on or to establish a certain ranking of importance of their objects.

1. A system for cleansing a fluid pathway of a fluid dispensing assembly, the system including:
an inlet to receive a supply of fluid to be delivered under pressure along the fluid pathway;
an outlet in fluid communication downstream of said inlet to dispense fluid; and
a replaceable cleansing cartridge locatable in fluid communication downstream of said inlet, the cartridge having at least a filter chamber and an anolyte generation chamber, the filter chamber including a filter medium and the anolyte generation chamber being configured to generate an anolyte, with the filter chamber and the anolyte generation chamber being in fluid communication so that the fluid received from the inlet passes through both chambers before exiting the outlet to deliver fluid to the fluid dispensing assembly.

2. The system according to claim 1, wherein the cartridge further includes a key or cap and a base configured to close a generally tubular housing defining a longitudinal axis, with the housing surrounding the chambers.

3. The system according to claim 1 or 2, wherein the cartridge further includes an electrolytic system having an electrode assembly.

4. The system according to claim 3, wherein the electrode assembly includes a cathode plate and an anode plate, with the cathode plate and the anode plate being spaced apart to allow fluid to travel therebetween.

5. The system according to claim 4, wherein the fluid travelling along the fluid pathway reacts with the electrode assembly to generate the anolyte.

6. The system according to any one of the preceding claims, wherein the anolyte being generated is at a low concentration level to maintain a clean fluid pathway.

7. The system according to claim 6, wherein the concentration of the anolyte being generated is maintained at between 0.2 to 0.5 ppm.

8. The system according to any one of claims 4 to 7, wherein the system is adapted to periodically switch the polarity of the cathode and anode plates.

9. The system according to any one of claims 4 to 8, wherein the electrode assembly further includes a passive electrode.

10. The system according to any one of the preceding claims, further including a pressure compensating flow restrictor configured to regulate a flow rate of the fluid delivered to the fluid pathway to facilitate mixing of the fluid within the cleansing cartridge to an effective cleansing concentration.

11. The system according to any one of the preceding claims, wherein the filter medium includes a pleated membrane, a particulate removal medium and/or a carbon filtration material.

12. The system according to any one of the preceding claims, wherein the anolyte generated by the anolyte generation chamber is hypochlorous acid.

13. The system according to any one of claims 1 to 12, wherein the chambers are spaced in series axially along said axis, with the anolyte generation chamber being located downstream from the filter chamber.

14. The system according to any one of claims 1 to 12, wherein the chambers are spaced parallel radially about said axis.

15. The system according to any one of claims 1 to 12, wherein the chambers are sequentially connected with fluid passing firstly through the filter chamber and subsequently through the anolyte generation chamber.

16. The system according to any one of claims 2 to 15, wherein the key includes a fluid inlet port to permit fluid moving into the cartridge, a fluid outlet port to permit fluid to move out of said cartridge.

17. The system according to any one of claims 2 to 16, wherein the key includes an electrical port to energise the electrolytic system located within said cartridge.

18. The system according to any one of claims 2 to 17, the key includes at least one sensor to measure characteristics of the cartridge and/or fluid traveling along the fluid pathway.

19. The system according to any one of claims 2 to 18, the key includes key portions operatively associated with corresponding lock portions on a head of said fluid dispensing assembly.

20. The system according to claim 19, wherein the key and lock portions include a mechanical arrangement.

21. The system according to claim 19, wherein the key and lock portions include an electronic arrangement.

22. The system according to any one of the preceding claims, further including a UV unit locatable along said fluid pathway.

23. The system according to any one of the preceding claims, further including a control unit to operate tasks within said cartridge, the control unit being electrically connected to said electrical port.

24. The system according to claim 23, wherein one said task is a self-cleaning/sanitising function.

25. The system according to claim 23, wherein one said task includes scheduling and sequencing of electrochemical metering.

26. The system according to any one of claims 23 to 25, wherein the control unit is capable of sending data via a signal to an external server to relay performance and water quality information to said server.

27. The system according to any one of claims 23 to 26, wherein the control unit provides real time location tracking of said cartridge.

28. The system according to any one of claims 23 to 27, the control unit responds to a user input to conduct a cleansing/sanitising cycle of the fluid pathway.

29. The system according to any one of claims 23 to 28, wherein when a new cartridge is installed in said fluid dispensing assembly, said control unit activates a cleansing/sanitising cycle, said sensor determining a cleansing/sanitising dwell time by determining the system's ability to generate anolyte of a particular concentration.

30. The system according to claim 29, wherein said dwell time ranges from 8 minutes to 24 minutes of cleansing/sanitising.

31. The system according to any one of claims 2 to 30, wherein the electrolytic system further includes upper and lower electrolytic electrode plates locatable within corresponding grooves within upper and lower supports, said supports including apertures adapted to direct fluid through said plates, and an elongate electrode extending from said key towards said base and electrically connected to said electrical port such that said electrode can create an electrochemical reaction within said cartridge to said fluid as it travels along said fluid pathway.

32. The system according to any one of claims 23 to 31, wherein the control unit is configured to control the flow to current ratio to control a concentration of anolyte in the fluid pathway.

33. The system according to any one of the preceding claims, wherein the system provides a continuous, in line low-level cleansing of the fluid pathway.

34. A replaceable cleansing cartridge to be operatively associated with a system for cleansing a fluid pathway of a fluid dispensing assembly, the cartridge including a key and a base configured to close a generally tubular housing defining a longitudinal axis, the housing surrounding the chambers, the cartridge include a filter chamber and an anolyte generation chamber, the filter chamber including a filter medium and the anolyte generation chamber being configured to generate an anolyte, the chambers being in fluid communication so that said fluid passes through both chambers before exiting said outlet to deliver cleansed fluid to the fluid dispensing assembly.

35. The cartridge according to claim 34, wherein the cartridge provides continuous, in line low-level cleansing of the fluid pathway.

36. The cartridge according to claim 35, wherein the key is configured to be utilised with existing canisters and/or dispensing assemblies.

37. A method of cleansing a fluid pathway of a fluid dispensing assembly, the method including the steps of:
providing a flow of fluid to a replaceable cleansing cartridge, wherein the cartridge includes a filter chamber and an anolyte generation chamber, the flow of fluid passing firstly through the filter chamber and subsequently through the anolyte generation chamber;
generating a sanitising anolyte in the fluid via the anolyte generation chamber; and
delivering the fluid from the anolyte generation chamber to a fluid dispenser of the fluid dispensing assembly.

38. The method according to claim 37, wherein fluid delivered to the fluid dispenser has a low level or concentration of the sanitising anolyte.

39. The method according to claim 37 or 38, the method further includes a step of measuring a level of free chlorine in the fluid and adjusting the concentration of the santising anolyte being generated based on the level of free chlorine detected.

40. The method according to claim 39, wherein the step of measuring and adjusting provides a feedback system for a continuous cleansing of the fluid pathway.

41. The method according to claim 39 or 40, further including a step of stopping the flow of fluid and de-energising the anolyte generation chamber to stop the generation of anolyte in the fluid.

42. The method according to claim 41, further including a step of maintaining the level or concentration of the sanitising anolyte in a dwell stage to keep the fluid pathway clean.

43. The method according to any one of claims 37 to 42, further including a step of regularly generating the sanitising anolyte in the fluid during periods of high usage.

44. The method according to any one of claims 37 to 43, further including a step of maintaining the anolyte generation at a rest or dormant state during periods of low usage.
